(19) United States
(12) Patent Application Publication
(10) Pub. No.: US 2015/0008667 A1
(43) Pub. Date: Jan. 8, 2015

(54) TIGHTLY THREADED JOINT FOR OIL FIELD PIPES

(71) Applicants: Boris Yur'evich SHCHERBAKOV, Taganrog Rostovskaya obl. (RU); Vladimir Petrovich ALDOXIN, Taganrog Rostovskaya obl. (RU); Yurij Fyodorovich VEMEL'YANOV, Taganrog Rostovskaya obl. (RU); Aleksej Sergeevich MYSLEVTCEV, Taganrog Rostovskaya obl. (RU); Pavel Nikolaevich SIDORENKO, Taganrog Rostovskaya obl. (RU)

(72) Inventors: Boris Yur'evich SHCHERBAKOV, Taganrog Rostovskaya obl. (RU); Vladimir Petrovich ALDOXIN, Taganrog Rostovskaya obl. (RU); Yurij Fyodorovich VEMEL'YANOV, Taganrog Rostovskaya obl. (RU); Aleksej Sergeevich MYSLEVTCEV, Taganrog Rostovskaya obl. (RU); Pavel Nikolaevich SIDORENKO, Taganrog Rostovskaya obl. (RU)

(21) Appl. No.: 14/495,831

(22) Filed: Sep. 24, 2014

Related U.S. Application Data
(63) Continuation-in-part of application No. 12/955,681, filed on Nov. 29, 2010, now abandoned.

(51) Int. Cl. E21B 17/042; F16L 15/06; E21B 17/08

(52) U.S. Cl. CPC E21B 17/042; E21B 17/08; F16L 15/06
USPC 285/334

(57) ABSTRACT

A threaded joint for oil field pipes includes a male pipe having a male thread and a female pipe having a female thread. The male thread and the female thread engage along a thread profile, the male pipe with a first end face and the female pipe with a second end face. The male pipe also has as first sealing surface and the female pipe has a second sealing surface. The first end face and second end face are substantially perpendicular to the first sealing surface and second sealing surface. When the male pipe and female pipe are fully adjoined, the first sealing surface abuts the second sealing surface, the first end face abuts the second end face, and the trailing face abuts female thread, while leaving a space between the female thread and the top face, and leaving a space between the female thread and the leading face.

This application is a continuation-in-part of application Ser. No. 12/195,681, filed on Nov. 29, 2010, which claims the benefit of the priority filing date in PCT/RU2008/000470 and referenced in WIPO Publication WO/2009/134160. The earliest priority date claimed is Apr. 30, 2008. Prior application Ser. No. 12/955,681 is currently pending.

### BACKGROUND

The utility model pertains to the field of construction and operation of vertical, controlled, directional and horizontal wells in severe operating conditions, and can be used for process casings.

Known is a tightly threaded joint for oil field pipes comprising a male and a female pipe with taper threads, and tapered sealing and bearing surfaces. The pipes contact each other. The outside surface of the end section of the male pipe is in the form of a tapered surface with the taper angle toward the pipe axis and contacts the inside surface of the female pipe in the area between the taper thread and the pipe body. The mating surface of the male pipe is in the form of a tapered end surface with the taper angle in the taper thread of the pipe pointing toward the mating tapered end surface of the female pipe, in the area where the first tapered surface of the female pipe blends into the pipe body (FR patent 2798716 E16L 15/00, published Mar. 23, 2001).

This technical solution is used as the prototype for the claimed utility model.

Under severe operating conditions (compression and excess torque), deformations occur in said threaded joint that disrupt the tapered contact surfaces and result in unsealing the threaded joint.

The utility model is aimed at solving the technical problem of preventing the unsealing of a joint under severe operating conditions when building long horizontal wells, and where there is a need to additionally load and turn a string when lowering the joint in order to prevent oil and gas from entering the environment.

The achieved technical result is increased operational reliability and effectiveness of a tight joint trader compression loads and torques, and minimized environmental risks when using the joint in a well.

This technical result is achieved in the form of a lightly threaded joint for oil field pipes that comprises a male pipe and a female pipe with taper threads, and bearing and sealing surfaces in which the pipes contact each other at the bearing end face and sealing surface of the male pipe and at the bearing end face and sealing surface of the female pipe. The bearing end faces and sealing surfaces have a taper thread profile that has a negative angle along the bearing end face. The height of the taper thread profile of the male pipe is lower than the height of the taper thread profile of the female pipe. The bearing end faces and sealing surfaces are made enlarged so that their area is equal to at least 60% of the pipe body.

### SUMMARY

The present invention is aimed at solving the technical problem of preventing the unsealing of a joint under severe operating conditions when building long horizontal wells, and where there is a need to additionally load and turn a string when lowering the joint in order to prevent oil and gas from entering the environment.

The achieved technical result is increased operational reliability and effectiveness of a tight joint under compression loads and torques, and minimized environmental risks when using the Joint in a well.

This technical result is achieved in the form of a tightly threaded joint for oil field pipes that comprises a male pipe and a female pipe with taper threads, and bearing and sealing surfaces in which the pipes contact each other at the bearing end face and sealing surface of the male pipe and at the bearing end face and sealing surface of the female pipe. The bearing end faces and sealing surfaces have a taper thread profile that has negative angle along the bearing end face. The height of the taper thread profile of the male pipe is lower than the height of the taper thread profile of the female pipe. The beating end faces and sealing surfaces are made enlarged so that their area is equal to at least 60% of the pipe body.

In a first alternative embodiment, a threaded joint for oil field pipes includes a male pipe having a male thread and a female pipe having a female thread, the male thread and the female thread being engaged along a thread profile. The male pipe includes a first end face and the female pipe having a second end face, and the thread profile is sloped to reduce the circumference of the male pipe toward the first end face.

The male pipe also has a first sealing surface and the female pipe includes a second sealing surface. The first end face and the second end face are substantially perpendicular to the first sealing surface and second sealing surface respectively. The male thread also comprises a cross-sectional trapezoidal shape having a trailing face oriented to have a swept, negative angle measured from vertical, a top face, and a leading face.

When the male pipe and the female pipe are fully adjoined, the first sealing surface abuts the second sealing surface, the first end face abuts the second end face, and the trailing face abuts female thread, while leaving a space between the female thread and the top face, and leaving a space between the female thread and the leading face.

In the first alternative embodiment, the end face of the male pipe may be at least 60% of the combined thickness of the male pipe and the female pipe. In a second alternative embodiment, the end face of the male pipe may no more than 40% of the combined thickness of the male pipe and the female pipe.

### BRIEF DESCRIPTION OF THE FIGURES

FIG. 1 is a cut-away view of a tightly threaded joint for oil field pipes comprising a male and female pipe.

FIG. 2 is an enlarged cut-away view of threads of the male and female pipe, displaying a line parallel to the thread axis.

FIG. 3 is an enlarged cut-away view of the male and female pipe, displaying the male pipe bearing end face and the female pipe bearing end face.

FIG. 4 is the cut-away view of the tightly threaded joint for oil field pipes showing relative thicknesses of the male and female pipes.

FIG. 5 is a diagram front view of the male and female pipes showing the relative thicknesses of the pipes.

### DESCRIPTION

The joint comprises a male pipe 1 and a female pipe 2, which are engaged along a taper thread 3 (shown schematically).

The joint end section comprises the male pipe bearing end face 4 and the female pipe bearing end face 5. It also comprises a radial sealing zone with an outside tapered male sealing surface 6 and an inside tapered female scaling surface 7.

The female pipe bearing end face 4 and the male pipe bearing end face 5, as well as the male sealing surface 6 and female sealing surface 7, interface under stress and are elements of the main seal that ensures the joint's tightness.

The joint uses a taper thread. The thread profile has a negative angle α, and the height of the thread profile of the male pipe 1 is lower than the height of the thread profile of female pipe 2. The main function of the thread is to carry a tensile load, a bending load and, as partially compressed load.

The “metal-to-metal” type sealing that provides tightness is located in front of the thread of the male pipe 1 on the side of the thread cone generatrix. Due to the sealing, the threaded joint acquires properties of an oil-and-gas-tight joint that can work under compound loads in corrosive environments.

Enlarging the bearing faces ensures the operability and effectiveness of the tight joint under compression loads and torques.

The fact that the height of the male pipe thread is lower than the height of the female pipe thread improves joint threading and increases the joint's resistance to wear.

The tight joint for oil field pipes works as follows. When performing the operations of joint screwing and unscrewing, the male pipe 1 and the female pipe 2 first interface by means of a thread 3. While screwing, the male sealing surface 6 interfaces with the female sealing surface 7. Due to diametrical deformations of these surfaces, a “metal-to-metal” sealing is created. As the male pipe 1 and female pipe 2 keep moving, a forced contact of the male pipe bearing end face 4 and the female pipe bearing end face 5 is created. As a result, contact stresses develop on their surfaces. The magnitude of the contact stresses is within the limits of elastic deformation. All other conditions being equal, the level of contact stresses is determined by the size of the contact areas of the male pipe bearing end face 4 and the female pipe bearing end face 5.

Increased operational reliability of the joint is achieved by enlarging the mating areas of the male pipe bearing end face 4 and the female pipe bearing end face 5. This makes it possible to increase the screwing torque while keeping the contact stresses at the required level within the limits of elastic deformation. The end of the process of screwing together the male pipe 1 and the female pipe 2 is accompanied by the interaction of the male pipe bearing end face 4 and the female pipe bearing end face 5. The surfaces of the end faces are made in such a way that their area is equal to at least 60% of the pipe body. This ensures the operability of a tight joint under compression loads and torques. It also increases its operational reliability and prevents an unsealing of the joint, thereby preventing environmental pollution.

Referring to figures one through three, a threaded pipe joint is shown. Figure one shows the male pipe 1 and a female pipe 2, engaged along a tapered thread 3.

Referring to figure two, Since the joint uses a taper thread, and the thread profile has a negative angle α, and the height of the thread profile of the male pipe 1 is lower than the height of the thread profile of female pipe 2, the main function of the thread is to carry a tensile load, a bending load and, a partially compressed load. Still referring to figure two, the thread comprises a negative angle feature. Specifically, the thread profile of the male pipe 1 has a trapezoidal shape of trapezoid with a bearing face 10 and a base face 11. The bearing face has a swept, negative angle α. Specifically, the angle between the normal line to thread axis 12 and bearing face 10 of the thread profile is less than 90 degrees.

Referring to figure three, the joint end section of the male pipe 1 shows a first bearing end face 4 and a second bearing end face 5 of the female pipe 2. Still referring to figure three, the joint also comprises a radial sealing zone with an outside tapered male sealing surface 6 and an inside tapered female sealing surface 7. In one embodiment there may be a space 9 between the male sealing surface 6 and female sealing surface 7. The first bearing end face 4 of the male pipe 1 and the second bearing end face 5 of the female pipe 2, as well as the male sealing surface 6 and female sealing surface 7, interface, under stress and are elements of the main seal that ensures the joint's tightness.

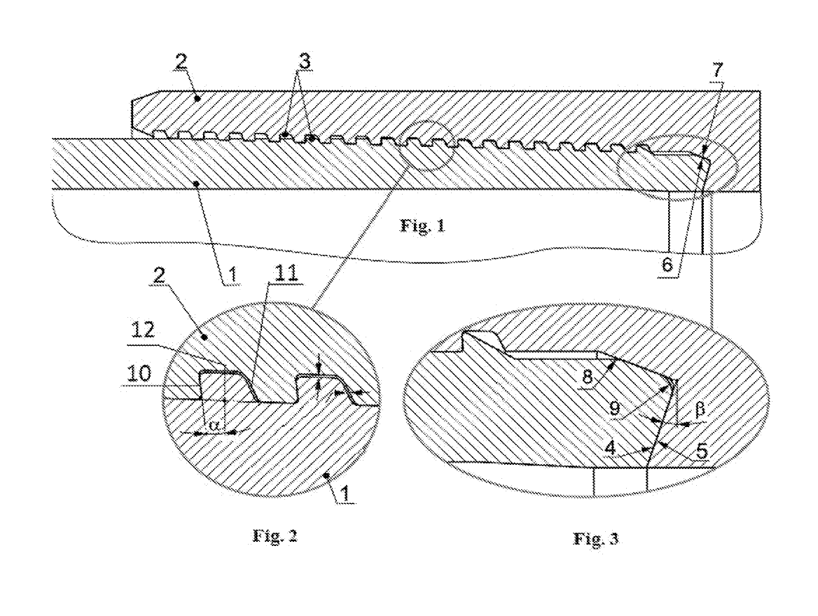

Still referring to figures one through three, a threaded pipe joint is shown in which the stop end surfaces of the male pipe 1 stop end surface 4 and female pipe 2 stop end (stop surfaces, FIG. 3—position 4, 5) are brought into contact with each other, and the sealing surfaces of the male and female pipes (sealing surfaces, FIG. 1—position 6, 7) are brought into contact with each other. Therefore, the male pipe and the female pipe are engaged along the stop end surfaces of the male and female pipes and along the sealing surfaces of the male and female pipes. Although there is contact along the thread when the male and the female pipes are screwed together, tightness of the joint is achieved through contact of the stop end surfaces of the male and female pipes and contact of the sealing surfaces of the male and female pipes.

Angle α is a negative angle in that the thread has a profile design with angles of slope of bearing α (in FIG. 2) relative to base angle β (in FIG. 3). In one embodiment thread three comprises a bearing face 10 is inclined to the opposite side in relation to the normal line to thread axis 12; therefore, its angle of slope is referred to as a negative one.

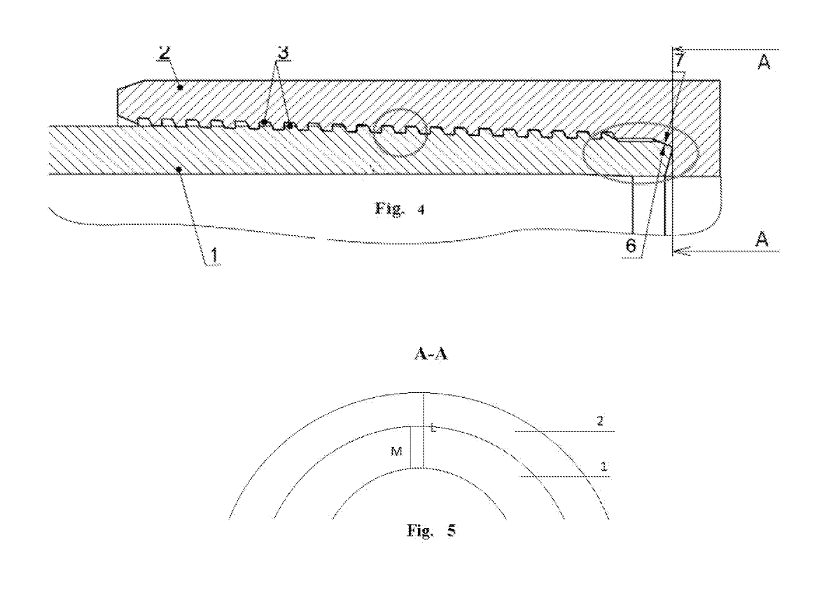

Referring to FIGS. 4 and 5, the areas of contacting stop end surfaces of the male pipe 1 and female pipe 2 are equal to at least 60% of the cross-section area of the relevant pipe body. As shown in FIG. 5, the partial width M of the male pipe 1, is at least 60% of the total width L of the male pipe 1 and female pipe 2 together.

The utility model is commercially practicable and novel.

The advantages of the claimed threaded joint compared to the prototype are improved operational reliability and effectiveness of the threaded joint, increased joint strength (which makes the job of assembling and disassembling the joint easier) and minimal environmental risks when using the joint in a well.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that dots not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 33 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A threaded joint for oil field pipes comprising:
a male pipe having a male thread;
a female pipe having a female thread:
the male thread and the female thread engaged along a thread profile;
the male pipe having a first end face and the female pipe having a second end face;
the thread profile sloped to reduce the circumference of the male pit toward the first end face;
the male pipe having a first sealing surface as the female pipe having a second sealing surface;
the first end face and the second end face substantially perpendicular to the first sealing surface and second sealing surface, respectively;
the male thread comprising a cross-sectional trapezoidal shape having a trailing face having a negative angle, a top face and a leading face;
wherein when the male pipe and the female pipe are fully adjoined, the first sealing surface abuts the second sealing surface, the first end face abuts the second end face, and the trailing face abuts female thread, while leaving a space between the female thread and the top face, and leaving a space between the female thread and the leading face; and
wherein the end face of the male pipe comprises at least 60% of the combined thickness of the male pipe and the female pipe.
